(19) United States
(12) Patent Application Publication
(10) Pub. No.: US 2002/0065354 A1
(43) Pub. Date: May 30, 2002

(54) Composition for the care and maintenance of water-resistant surfaces

(75) Inventors: Wolfgang Schnell, Munchen (DE); Christian Elbler, Munchen (DE)

Correspondence Address: DARBY & DARBY, 805 THIRD AVENUE, 27TH FLR., NEW YORK, NY, 10022, US

(73) Assignee: Dr. Schnell Chemie GmbH

(21) Appl. No.: 09/911,845

(22) Filed: Jul. 24, 2001

(30) Foreign Application Priority Data
Jan. 25, 2000 (EP) PCT/EP00/00553
Jan. 25, 1999 (DE) 199 02 772.2

(51) Int. Cl. C08L 1/00; C08J 3/00; C08K 3/34

(52) U.S. Cl. 524/492

(57) ABSTRACT

There is provided a composition for the care and maintenance of water-resistant surfaces, which contains the following components:

at least one mineral from the group of sheet silicates with an average mineral lamina size <10⁻⁷ m;

a non-ionic surfactant; the ratio of sheet silicate to surfactant ranging from 5:1 to 1:7; and/or

polyethylene glycol and/or polypropylene glycol.

The present invention relates to a care composition for water-resistant surfaces from the field of buildings and vehicles, in particular floors, which in particular in the dilute condition can be used for the care of surfaces. In a preferred embodiment, the composition also contains cleaning components, so that it can be used as sweeping care composition, i.e. a combination of cleaning and care composition, for the cleaning and care of the surfaces.

For the cleaning and care of floors numerous methods and compositions have already been developed. Compositions for the care and preservation of surfaces contain waxes or film-forming polymers as well as cross-linking substances such as heavy metal salts, which upon drying form a film on the surface treated. However, removing such films, for instance due to wear or soiling, is only hardly possibly.

Commercially available sweeping care products, by means of which cleaning and preserving the surface should be possible in one step, contain surfactants or a surfactant/polymer combination. In some cases, there may also be included a wax dispersion. An example for the combination of a special surfactant and a polymer as care/cleaning component in a sweeping care composition can be found in WO 94 20 595 A.

To achieve an appealing optical appearance, sweeping care products based on surfactants must be applied in two-stage sweeping methods and/or by means of automatic cleaning machines. In general, a subsequent polishing step is required. Polymer-containing sweeping care products in which this can be avoided, particularly easily tend to a build-up of the layers of care product, in particular when applied daily, for instance in hospitals, which due to the inclusion of dirt and the uneven thickness of the layered structure as a result of a different mechanical load, for instance in the vicinity of runways, leads to an unsightly appearance.

Proceeding from this prior art, a composition for the care of water-resistant surfaces should now be provided in accordance with the invention, which composition has the following properties:

little or no build-up of layers, which means a water-soluble/water-dispersible composition, so that during the next cleaning operation residues are for the most part removed together with the dirt;

reduced resoiling and/or facilitated removability of the dirt;

tread safety.

Furthermore, a sweeping care composition should be provided, which in addition has the following properties:

good soil-removing capacity, good wetting;

good optical appearance with a one-stage sweeping method, which means no formation of streaks or stains and development of gloss also without polishing, where the treated surface should, however, be polishable.

In accordance with the invention, there is now provided a composition for the care and maintenance of water-resistant surfaces with the above-mentioned properties, which comprises

at least one mineral from the group of sheet silicates (phyllosilicates) with an average mineral lamina size of <10⁻⁷ m;

a non-ionic surfactant; the ratio of sheet silicate to surfactant ranging from 5:1 to 1:7; and/or

polyethylene glycol and/or polypropylene glycol.

Upon evaporation of water and solvents, the composition provides a transparent film-like dry residue. The mineral swells in water to obtain a transparent solution. In this connection, “solution” is understood to be a transparent colloid-disperse system (colloidal solution; sol or gel) or a molecularly disperse system (true solution).

In accordance with the invention it was found that in order to achieve a low soiling tendency and a good coat absorption capacity of the treated surface, the air-dry residue of the composition should be solid and not sticky or brittle. Furthermore, it should be drying quickly. If the residue is liquid (upon evaporation of water and solvents), it attracts dust, so that the objective of a reduced resoiling cannot be reached. A too solid residue is crumbly. It was also noted that an optimum optical appearance, i.e. gloss and stainlessness, can also be obtained without polishing, with a transparent, good film-like dry residue. A semisolid consistency is optimal.

The above finding is surprising in so far as the air-dry residue of a care composition or a cleaning composition has little got to do with what remains on the floor as caring principle. The product is being used in very dilute form, so that the formation of a more or less closed film on the surface cannot be expected.

In accordance with the invention, it is furthermore important that the remaining substances are sufficiently water-soluble, in order not to build up, but so poorly or slowly soluble that on a long-term basis they are left in the pores, so that a sufficient preservation of the surface is ensured. It should be pointed out that these properties are not achieved with the commonly used combination of surfactant and acrylate/styrene acrylate as polymer in sweeping care compositions. The film-like polymers are hardly water-soluble, and the ratio of non-ionic surfactant/polymer should be minimized to obtain a solid residue.

In accordance with the invention, on the other hand, a sweeping care composition with a high content of non-ionic surfactant can be provided, which leaves no streaks and is wetting very well. The good wetting of the floor, which is possible by using the inventive sweeping care composition, not only prevents water stains, but also provides for achieving a sufficient cleaning effect with a one-stage sweeping method. The substances left upon sweeping allow to easily remove dirt produced during the next cleaning operation.

In accordance with the invention, there is also provided a composition for the care and maintenance of water-resistant surfaces, which has only little or no cleaning effect. This composition contains no surfactants or preferably only a small amount of surfactants wetting very well. A semisolid, transparent film is obtained in particular by combining the sheet silicate with a polyethylene glycol and/or polypropylene glycol.

From the prior art, cleaning compositions are already known, which contain silicates; these compositions are, however, not suited for the care and maintenance of surfaces, and to achieve the desired cleaning effect, the compositions are rinsed or swept off as completely as possible. WO 96/27654 A1, for instance, describes cleaning compositions in the form of sprayable thixotropic compositions whose cleaning effect is based on their acid content. Surfactants are not included in the compositions or only in a very small amount. DE 38 06 674 A1 relates to cleaning compositions which are especially proposed for cleaning (degreasing) metallic surfaces. The silicates referred to as suitable, however, swell in water at best to a small extent and do not form any colloidal solutions, so that a formation of transparent films is not possible either.

The ingredients of the inventive composition for the care and maintenance of water-resistant surfaces as well as preferred embodiments of the invention will be explained below.

The inventive composition contains at least one mineral from the group of sheet silicates (phyllosilicates) with an average mineral lamina size of ≦10⁻⁷ m. Preferably, the average size lies below 10⁻⁷ m, for instance is about 8·10⁻⁸ m or below, about 5·10⁻⁸ m or below, or about 3·10⁻⁸ m or below. Furthermore, the mineral material should preferably not contain a substantial amount of particles which are much larger than 10⁻⁶ m or, rather, larger than 10⁻⁷ m. Typically, the material does not contain more than 10%, rather not more than 1% and in particular not more than 0.1% (each by weight) of particles with a size of 10⁻⁷ m or above.

The silicates used in accordance with the invention typically form crystal lamina with a small thickness as compared to the diameter. As far as reference is made to the size of the particles, there should be meant the primary particle size in the case of a complete dispersion and more particularly the diameter of the particles. Independent of the precise particle shape, the largest dimension is decisive. In the case of crystal lamina, the diameter may for instance be more than 10 times or more than 20 times the thickness. Lamina whose diameter is 25 times or more the thickness are also suited. The thickness may for instance range from 9·10⁻¹⁰ to 4·10⁻⁹ m.

In accordance with the invention it is essential that the particles from the sheet silicate have colloidal dimensions. This is important for a complete swelling by forming a colloidal transparent system. In the silicates used in accordance with the invention, a complete swelling is frequently effected in less than 1 hour. Silicates which in water form a suspension or a turbid system, namely in particular due to an incomplete swelling, are not suited for the invention. The skilled person can easily test the swelling behavior by adding water to a silicate in an amount as it can be considered for the inventive composition, expediently by stirring or shaking, and then by observing whether the system obtained is transparent or turbid.

The sheet silicate used in accordance with the invention is a natural or synthetic sheet silicate, synthetic materials being preferred. The sheet silicates used are preferably free of contaminants which disturb or inhibit the formation of a transparent colloidal solution in water.

A preferred silicate component is a mica-like sheet silicate. Examples include natural smectites and sheet silicates produced on the basis of natural smectites or synthetic sheet silicates with a composition similar to the smectites. Hectorite as well as synthetic trioctahedral sodium magnesium silicates are particularly preferred. In particular with these lastmentioned sheet silicates can a completely clear dry residue be achieved.

The sheet silicates considered in accordance with the invention are known as such (cf. for instance Römpp Chemie Lexikon, 9th edition). This is especially true for the mica-like sheet silicates (cf. for instance Ullmanns Encyklopädie der technischen Chemie, 4th edition, vol. 21, pp. 373 to 375). They are derived from pyrophyllite (Al₂(OH)₂[Si₄O₁₀]) and talcum (Mg₃(OH)₂[Si₄O₁₀]) and have the following general formula:

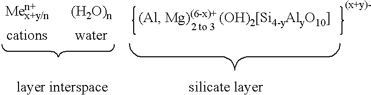

The layer charge (x+y) generally is 0 to 2. Smectites have a layer charge x+y per (Si, Al)₄O₁₀ unit of 0.2 to about 0.6, where: x>y. Typical cations in the octahedron layer are Al³⁺ and Mg²⁺, in the intermediate layer Mg²⁺, Ca²⁺, Na⁺, K⁺ and Li. When the Mg²⁺ ions in the octahedron layer prevail, reference is made to trioctahedral silicates. There may be used both natural and synthetic materials, but synthetic products are preferred.

In accordance with the invention it is important that these sheet silicates, possibly together with further ingredients as they are used in the compositions of the present invention, are capable of forming films. Products on the basis of attapulgite, a rod-like or bundle-shaped magnesium-aluminum-hydrosilicate, provided no suitable dispersions or films.

In accordance with the invention, the size of the mineral lamina is also important. When a material for instance on the basis of natural smectites (such as bentonite, whose chief component are smectites) is used as silicate component, suitable dispersions or films cannot be achieved when the lamina are >10⁻⁷ m. Experiments with silicates on the basis of natural bentonite (Avocado, Rheox), natural hectorite (Celeste) and attapulgite (Chemie Mineralien) had a negative outcome; the dispersions in a surfactant solution (Simulsol® NW 900) were muddy. The air-dry residues were turbid, powdery or greasy, in any case hardly film-like and not transparent. Bentonites, kaolins and/or hectorites, which at best swell incompletely in water at room temperature within 24 hours, are not suited either.

In general, the silicate component used in accordance with the invention should swell in water to form a transparent solution and upon drying the aqueous solution should provide transparent solid films. For the transparency of the dispersion and the formation of a film the swelling of the silicate, which may be impaired by impurities, and the particle size are of decisive importance.

In accordance with the invention it is furthermore preferred when the mineral lamina of the silicate component conduct electricity and/or absorb moisture by forming an electrically conductive material. This leads to an antistatic effect on the surface treated. One consequence is a reduced attraction of dust.

As has already been mentioned, smectites are preferred as silicate component in the present invention, as they swell particularly well with water. Synthetic trioctahedral alkali metal magnesium silicates are more preferred, the synthetic products being generally characterized by a higher purity and a well adjusted particle size as compared to natural minerals.

Synthetic alkali metal magnesium silicates, whose composition is similar to that of smectites, to be more precise to that of hectorites, are commercially available for instance as Laponite® RD/RDS (Laporte) and Optigel® SH/EX (Süd-Chemie). Such products are characterized by mineral lamina with a small size (not more than 10⁻⁷ m). They are used as thixotroping compositions. The effect of thixotropy is, however, not important in the present invention and preferably is even avoided.

Laponite® RD (Laporte, CAS No. 53320-86-8) is a synthetic sheet silicate, which is commercially available as white, free-flowing powder. When dispersed in water it forms a thixotropic transparent gel, unless gelling is prevented by suitable additives. These additives, which are also referred to as liquefiers, include for instance certain phosphonates, condensed phosphates, for instance tetrapotassium pyrophosphate, low-molecular polyethylene glycols or polypropylene glycols. Examples for liquefiers are indicated in EP 0 675 176 A. Liquefiers having stability against hydrolysis are preferred, in order to provide compositions which maintain their consistency over an extended period. The amount of liquefier may be chosen in dependence on the desired consistency (viscosity) of the composition. An example for a silicate to which such liquefier has been added is Laponite® RDS (Laporte, CAS No. 53320-86-6). This product contains tetrasodium pyrophosphate and when dispersed in water forms a transparent free-flowing sol.

The use of a liquefier is preferred in accordance with the invention. However, the liquefier is not important for the care effect of the composition. Due to the thickening effect of the silicate, the application properties of the composition can, however, be worse in some cases, when no liquefier is used. For the properties of the composition for the care and maintenance of water-resistant surfaces it is irrelevant whether a liquefier is already added to the silicate or is only added during the manufacture of the composition.

Further synthetic silicates that can be used in accordance with the invention are commercially available as Optigel® SH (Süd-Chemie, CAS No. 12173-47-6), which at a low dosage in water already forms highly viscous transparent gels, and Optigel® EX, which when dispersed in water forms transparent, low-viscosity suspensions, where an added amount of up to 25% can technically be handled.

The sheet silicates used in accordance with the invention typically have bulk densities of more than 650 g/l and in particular bulk densities in the range from 800 to 1000 g/l.

When the composition in accordance with the invention is provided as concentrate, the content of the silicate component, based on 100 parts of the composition, preferably is 0.5 to 20 parts, in particular 1 to 15 parts and quite particularly preferably 2 to 5 parts.

Apart from the sheet silicate, the inventive sweeping care composition contains a non-ionic surfactant. Non-ionic surfactants mostly are liquid. Frequently, they are better wetting agents than other kinds of surfactants and do not form streaks on a treated surface. In principle, all kinds of nonionic surfactants can be considered as non-ionic surfactants.

What is particularly useful is a surfactant which includes ethylene glycol groups and/or propylene glycol groups. For instance, such surfactants are addition products of 3 to 20 mol ethylene oxide to primary C₈ to C₂₀ alcohols, such as to coconut fat or tallow fat alcohols, isotridecyl alcohols, oleyl alcohol, oxoalcohols or secondary alcohols with this chain length. The corresponding ethoxylation products of other long-chain compounds such as those of fatty acids or fatty acid amides with 12 to 18 C atoms likewise can be considered. Instead of the ethylene oxide addition products there may also be used products in which the ethylene oxide has wholly or partly been replaced by propylene oxide. There can in addition be considered the water-soluble addition products of ethylene oxide to polypropylene glycol, alkylene diamine polypropylene glycol and alkyl polypropylene glycol with 1 to 10 carbon atoms in the alkyl chain, which addition products include 20 to 250 ethylene glycol ether groups and 10 to 100 propylene glycol ether groups, the propylene glycol chain representing a hydrophobic radical. Among the above-mentioned non-ionic surfactants, the addition products of 3 to 10 mol ethylene oxide to long-chain primary alcohols with 8 to 18 C atoms from the group of oxoalcohols and natural fatty alcohols are preferred in accordance with the invention. A particularly preferred non-ionic surfactant has been derived from a fatty alcohol and from alkylene oxide groups, exhibits little foaming, is a very good wetting agent and biodegradable. An example for such product is Simulsol® NW 900 of the firm Seppic.

Apart from the above-mentioned non-ionic surfactants, alkyl polyglycosides can, for instance, also be considered. These are surfactants with the general formula R—O(—G)ₙ, wherein R designates an alkyl radical with 8 to 22 C atoms, G designates a glycosidically bound radical of a monosaccharide, and n means a value between 1 and 10.

When the inventive composition is provided as concentrate, the non-ionic surfactant may be contained in the composition in an amount of up to 40 parts by weight, based on 100 parts of the composition. Preferably, the amount of the surfactant is 1 to 15 parts and in particular 2 to 10 parts by weight.

The inventive composition may furthermore contain polyethylene glycol (PEG) and/or polypropylene glycol (PPG), where in particular compounds with an average molecular weight (number average) between 200 and 20,000 and preferably from 1,000 to 10,000 are used.

By varying the ratio of the components non-ionic surfactant, polyethylene glycol and polypropylene glycol on the one hand to the sheet silicate on the other hand, the hardness of the air-dry residue can be adjusted. One possible explanation, which should, however, not limit the scope of the invention, consists in that the surfactant and/or the polyethylene glycol or polypropylene glycol are included between the mineral lamina, which impede the aggregation of the mineral lamina during the evaporation of water and/or organic solvents and thus exert a plasticizer effect. In accordance with the invention it was noted that a medium-hard (i.e. solid, but not brittle) residue leads to a product with the best properties.

In the inventive composition, the ratio of sheet silicate/surfactant ranges from 5:1 to 1:7. The exact value depends on the chosen non-ionic surfactant. There is preferably used a ratio in the range from 3:1 to 1:5, more preferably from 2:1 to 1:5 and particularly from 1:1 to 1:4, particularly good properties being achieved with a ratio of 1:2, in particular when using a surfactant as mentioned above, which is preferred in accordance with the invention. The ratio values are by weight. This is also true for all other ratio values, quantities and percentages, unless something else has expressly been indicated.

The ratio of silicate on the one hand to polyethylene glycol and polypropylene glycol on the other hand preferably is about 1:10 to 20:1 and more preferably 1:5 to 15:1. The exact value depends on the chosen PEG or PPG and also on the surfactant, if a surfactant is used, and can easily be determined by means of experiments. When there is used for instance a PEG with an average molecular weight of 4000, the ratio of silicate to PEG preferably is about 10:1.

The inventive composition for the care and maintenance of water-resistant surfaces can also include one or more optional ingredients. These include

(a) wetting agents/flow-control agents, for instance a fluorinated surfactant or diisooctyl sulfosuccinate. As fluorinated surfactant there may, for instance, be used Fluorad® FC-129 (3M Deutschland). This component improves wetting and flow.

The inventive composition may in addition include

(b) a sequestering agent, such as nitrilotriacetate.

It is furthermore possible

(c) to use a composition for adjusting the pH value, such as citric acid or potassium hydroxide solution, in order to fix the pH value. Typically, the inventive composition reacts subacid to subalkaline (pH 3 to 12). Independent of whether or not a composition for adjusting the pH value is included, the inventive composition for care and maintenance should preferably have a pH value in the indicated range. In any case, the pH value should more preferably lie in the range from 4 to 11, even more preferably from 4 to 10 and in particular from 5 to 10. A neutral or approximately neutral pH value, for instance from 6 to 9, is especially preferred.

The inventive composition typically contains water as solvent. It is also possible to

(d) add a water-miscible organic solvent. Examples include alcohols and glycols, such as isopropanol and butyl diglycol. The organic solvent may be included in an amount of 0% to 10% and preferably 2% to 7%. Isopropanol for instance acts as solubilizer and, if a perfume is included, intensifies the effect of this component.

There may also be used

(e) a solubilizer such as sodiumcumol sulfonate. This compound is used for instance as an about 40% solution. The solubilizer for instance serves to raise the turbidity point of the surfactant solution.

To the inventive composition there may furthermore be added

(f) usual preservatives, and

(g) perfume oils.

The composition may also include

(h) anionic surfactants.

As anionic surfactants, there can for instance be considered synthetic anionic surfactants such as those of the sulfonate or sulfate type. Examples for surfactants of the sulfonate type include alkyl benzene sulfonates and alkane sulfonates. Examples for surfactants of the sulfate type include sulfuric acid monoesters of long-chain alcohols as well as other sulfated aliphatic compounds such as in particular sulfuric acid monoesters of the aliphatic long-chain primary alcohols or ethoxylated secondary alcohols, respectively, ethoxylated with 1 to 6 mol ethylene oxide. The anionic surfactants are preferably used als alkali salts, in particular sodium salts. Since anionic surfactants easily lead to a rather solid dry residue, they are preferably used in a smaller amount in the inventive composition for the care and maintenance of water-resistant surfaces.

The inventive composition may also include

(i) cationic surfactants.

These are for instance quaternary ammonium compounds. Since when using these compounds in larger amounts there is a risk that hardly removable residues are left on the treated surface, cationic surfactants are preferably used only in small amounts.

Furthermore, the inventive composition may also include other surfactants, such as

(j) amphoteric surfactants, and

(k) soaps,

if this is expedient to achieve particular effects and the remaining good properties of the composition are not impaired thereby.

The inventive composition is used for the care and/or for the cleaning and care of water-resistant surfaces. It is particularly useful for water-resistant hard floor coverings, for instance linoleum, PVC, Mipolam®, polyolefin, sealed wood/parquetry, laminate, artificial stone/natural stone and fine stoneware tiles. It is also especially useful for acrylate/polyurethane-coated floor coverings. The treatment is typically effected by a method in which first of all the composition is diluted with water to a use-level, and the dilute composition is then applied onto the surface. When the inventive composition is formulated as sweeping care product, which is present as concentrate and contains 1% to 45%, preferably 2% to 30%, in particular 4% to 15% and quite particularly preferably 5% to 10% of a mixture of silicate and non-ionic surfactant, it is uniformly distributed on the surface for instance by means of a fringe mop or a wet-sweeping cover upon dilution with water. The use-level of the composition depends on the intendend use. When the concentrate contains for instance 4% surfactant and 2% silicate component, the composition may be used upon dilution with water to 0.1% to 30%. For the care of aetites, there is preferably used a high concentration of, for instance, 10%. For daily cleaning, a much lower concentration, for instance a dilution to 0.25%, is preferred. For spray-cleaning there can for instance be used a concentration of 20%. For the various applications, the inventive composition can of course also be provided as ready-made preparation, so that diluting can be omitted. There is typically used a one-stage application; in the case of heavy soiling, however, a two-stage wet sweeping is possible. Polishing upon drying is possible due to the content of surfactants, but is not required. In order to achieve the desired care effect, a sufficient amount of the non-volatile ingredients of the inventive composition must be left on the treated surface.

The inventive composition can also be formulated as spray-sweeping care product. It is then applied by preparing a dilute spray solution, by spraying it onto soiled areas and by picking up the dirt liquor with an absorbent sweeping cover. The use of inventive compositions as spray-sweeping care products is particularly preferred.

For making the inventive composition the silicate, possibly together with a liquefier, should preferably first be dispersed in pure water and then the other components should be added. The silicate can also be used in the form of a concentrated solution or suspension as well as a stock paste.

The invention will now be explained in detail by means of examples.

### EXAMPLE 1:

### Formulation for a Care Composition

| Ingredient | Parts by weight |
|---|---|
| Water | 70 |
| Optigel ® EX 0482 (synthetic sheet silicate, | 5 |
| Süd-Chemie) | |
| Rewopol ® SBDO 75 (diisooctyl sulfosuccinate, | 0.2 |
| 75%, quick wetter, Witco Surfactants) | |
| Polyethylene glycol 4000 (average | 0.5 |
| molecular weight = 4000, Hoechst) | |
| Perfume oil, alcohols, preservatives, | q.s. |
| etc. | |

### EXAMPLE 2:

### Formulation for a Sweeping Care Composition

| Ingredient | Parts by weight |
|---|---|
| Water | 87.4 |
| Optigel ® EX 0482 | 2.2 |
| Isopropanol | 4.5 |
| Simulsol ® NW 900 | 4.4 |
| Perfume oil | q.s. |
| Dye | q.s. |
| Fluorad ® FC 129 (wetter) | 0.044 |
| Sodiumcumol sulfonate | 0.35 |

### EXAMPLE 3:

### Smoothness and Gloss of Treated Surfaces

To examine the effect of the silicate component used in accordance with the invention and in particular determine the relation between the consistency of the dry residue and the smoothness and the gloss of treated surfaces, experiments were made with three test formulations.

Test formulation 1, which provided a solid dry residue, had the following composition (parts by weight):

| Ingredient | Parts by weight |
|---|---|
| Water | 100 |
| Optigel ® EX (synthetic sheet silicate, | 5 |
| Süd-Chemie) | |
| Simulsol ® NW 900 (non-ionic surfactant, Seppic) | 5 |
| Isopropanol | 5 |

Test formulation 2, which provided a semi-solid dry residue, had the following composition:

| Ingredient | Parts by weight |
|---|---|
| Water | 100 |
| Optigel ® EX | 2.5 |
| Simulsol ® NW 900 | 5 |
| Isopropanol | 5 |

Test formulation 3 finally contained no silicate and provided a liquid dry residue. It had the following composition:

| Ingredient | Parts by weight |
|---|---|
| Water | 100 |
| Simulsol ® NW 900 | 10 |

Application solutions were prepared by adding 20 ml cleaner each of the above-mentioned composition to 10 l water. Floor coverings of black linoleum and white PVC were swept therewith daily by a one-stage method. The swept floors were in the aisles of offices which were frequented to an average extent, so that the coverings were correspondingly subjected to wear and soiling. In intervals of a few days each smoothness and gloss were determined. The smoothness was measured by means of a device named Floor-slide-Control FSC 2000 of the firm Elcon GmbH. The gloss was measured according to DIN 67530 by means of a single-angle reflectometer with the designation REFO 60 of the firm Langer. The results are summarized in the following tables:

Smoothness values for black linoleum:

| Test | Day 1 | | | | | |
|---|---|---|---|---|---|---|
| formulation | (start) | Day 13 | Day 27 | Day 35 | Day 46 | Day 57 |
| 1 | 0.27 | 0.28 | 0.29 | 0.31 | 0.32 | 0.35 |
| 2 | 0.27 | 0.28 | 0.30 | 0.35 | 0.40 | 0.42 |
| 3 | 0.28 | 0.28 | 0.30 | 0.30 | 0.30 | 0.31 |

Smoothness values for white PVC:

| Test | Day 1 | | | | | |
|---|---|---|---|---|---|---|
| formulation | (start) | Day 13 | Day 27 | Day 35 | Day 46 | Day 57 |
| 1 | 0.51 | 0.54 | 0.56 | 0.60 | 0.57 | 0.61 |
| 2 | 0.51 | 0.55 | 0.58 | 0.64 | 0.61 | 0.66 |
| 3 | 0.50 | 0.50 | 0.52 | 0.55 | 0.53 | 0.55 |

The smoothness values represent the tread safety, and the values can be divided into the following ranges:

| | |
|---|---|
| 0.63-1.00 | very safe |
| 0.42-0.63 | safe |
| 0.29-0.42 | moderately safe |
| 0.21-0.29 | unsafe |
| 0.00-0.21 | very unsafe |

Note:
The measured values determined in the tables on day 1 describe the blank value which was determined on a covering to which no care product had been applied.

Gloss values for black linoleum:

| Test | Day 1 | | | | | |
|---|---|---|---|---|---|---|
| formulation | (start) | Day 13 | Day 27 | Day 35 | Day 46 | Day 57 |
| 1 | 4.0 | 4.5 | 4.9 | 5.5 | 6.3 | 6.3 |
| 2 | 3.9 | 4.2 | 5.0 | 5.4 | 5.5 | 5.9 |
| 3 | 4.1 | 2.6 | 2.8 | 3.5 | 4.0 | 4.1 |

Gloss values for white PVC:

| Test | Day 1 | | | | | |
|---|---|---|---|---|---|---|
| formulation | (start) | Day 13 | Day 27 | Day 35 | Day 46 | Day 57 |
| 1 | 28.3 | 32.6 | 32.8 | 34.9 | 38.7 | 38.9 |
| 2 | 28.3 | 29.4 | 34.1 | 37.0 | 40.0 | 44.3 |
| 3 | 28.2 | 33.9 | 34.0 | 34.9 | 36.5 | 38.0 |

In the tables, higher numerical values mean a higher gloss.
Note: The measured values determined in the tables on day 1 describe the blank value which was determined on a covering to which no care product had been applied.

In the tables, higher numerical values mean a higher gloss.

Note: Thee measured values determined in the tables on day 1 describe the blank value which was determined on a covering to which no care product had been applied.

The above data demonstrate that when using a sheet silicate in combination with a non-ionic surfactant both good gloss and good tread safety can be achieved, which are superior to those achieved when using a surfactant alone. Furthermore, the test results demonstrate that the best values are obtained with a composition which provides a semisolid dry residue.

1. A composition for the care and maintenance of water-resistance surfaces, comprising:
(A) at least one mineral from the group fo sheet silicates with an average mineral lamina size of <10⁻⁷ m;
(B) a non-ionic surfactant, the ratio of sheet silicate to surfactant ranging from 5:1 to 1:7; and/or
(C) polyethylene glycol and/or polypropylene glycol.

2. The composition as claimed in claim 1, wherein the sheet silicate is a synthetic material.

3. The composition as claimed in claim 1, wherein the sheet silicate is a mica-like sheet silicate.

4. The composition as claimed in claim 3, wherein the silicate component has been chosen from among natural smectites and sheet silicates prepared on the basis of natural smectites or synthetic sheet silicates with a composition similar to that of smectites.

5. The composition as claimed in claim 4, wherein the sheet silicate is hectorite or a synthetic trioctahedral alkali metal magnesium silicate.

6. The composition as claimed in claim 1, which in addition contains a liquefier, in order to eliminate the thixotropy effect of the sheet silicate.

7. The composition as claimed in claim 1, which contains a non-ionic surfactant with ethylene glycol groups and/or propylene glycol groups.

8. The composition as claimed in claim 1, which contains polyethylene glycol and/or polypropylene glycol with a molecular weight in the range between 200 and 20,000.

9. The composition as claimed in claim 1, which in addition contains one or more of the following ingredients:
(a) wetting agent/flow-control agent,
(b) sequestering agent,
(c) agent for adjusting the pH value,
(d) water-miscible organic solvent,
(e) solubilizer,
(f) preservative,
(g) perfume oil,
(h) anionic surfactant,
(i) cationic surfactant,
(j) amphoteric surfactant,
(k) soap.

10. The composition as claimed in claim 1, wherein the ratio of sheet silicate to surfactant ranges from 3:1 to 1:5.

11. The composition as claimed in claim 10, wherein the composition contains 1 to 45% of the combination of sheet silicate and surfactant, the rest water and optional ingredients.

12. The composition as claimed in claim 1, wherein the ratio of silicate to polyethylene glycol and polypropylene glycol ranges from 1:10 to 20:1.

13. Use of a mineral from the group of sheet silicates with an average mineral lamina size <10⁻⁷ m for the care and maintenance of water-resistant surfaces.

14. A method for the cleaning and care of water-resistant surfaces, wherein first of all a composition as claimed in claim 1 is diluted with water to the use-level and the dilute composition is then applied onto the surface.
